(19) United States
(12) Patent Application Publication
(10) Pub. No.: US 2005/0190936 A1
(43) Pub. Date: Sep. 1, 2005

(54) Sound pickup apparatus, sound pickup method, and recording medium

(76) Inventors: Masayoshi Miura, Chiba (JP); Susumu Yabe, Tokyo (JP)

Correspondence Address: William S. Frommer, Esq.;FROMMER LAWRENCE & HAUG LLP, 745 Fifth Avenue, New York, NY, 10151, US

(21) Appl. No.: 11/049,810

(22) Filed: Feb. 3, 2005

(30) Foreign Application Priority Data
Feb. 6, 2004 (JP) 2004-030877

(51) Int. Cl. H04R 5/00; H04R 5/02

(52) U.S. Cl. 381/309; 381/26

(57) ABSTRACT

A sound pickup apparatus capable of providing a target sensation of sound localization to a listener by using a standard head-related transfer function is provided. In a microphone amplifying section of a sound pickup block, only the high frequency components of a signal for a left ear and a signal for a right ear, which are input from a dummy head microphone, are delayed by a delay circuit. In this case, since the reproduction sound of the low frequency components having small individual differences is output earlier from speakers of a playback block, a listener in a reproduction sound field space can perceive the sensation of sound localization by the reproduction sound of the low frequency components that arrive earlier. As a result, even when a standard head-related transfer function is used, it becomes possible to enable the listener in the reproduction sound field space to perceive the target sensation of sound localization.

### BACKGROUND OF THE INVENTION

1. Field of the Invention

The present invention relates to a sound pickup apparatus, a sound pickup method, and a recording medium on which sound signals that are picked up by the sound pickup apparatus and the sound pickup method are recorded.

2. Description of the Related Art

Hitherto, various sound pickup methods have been proposed to reproduce sound reception in an original sound field such as a concert hall in a listening room.

For example, when the sound reception of a concert hall is reproduced in a listening room by using a stereophonic sound reproduction system, a sound signal that is radiated from a sound source, such as a musical instrument, and that arrives at the ears of the audience accompanied with the reverberations of the hall is necessary. It is known that such a sound signal is obtained by picking up sound by using a dummy head microphone such that microphones are mounted at the positions of two ears of a dummy head based on the shape of the head of a human being, that is, by binaural sound pickup.

Examples of binaural sound pickup include a method in which a sound signal that arrives at the ears of the audience is directly recorded by arranging a dummy head microphone in a seat of a concert hall, and a method in which sound is recorded by electrically superposing propagation characteristics from the position of the sound source to the ears of a listener, which are determined by measurements or simulation, onto a signal of a sound source such as a musical instrument. In the former case of the sound pickup method for directly picking up sound, the propagation characteristics from the position of the sound source to the ears of the listener are acoustically superposed onto the sound from the sound source.

Furthermore, a sound apparatus for obtaining a sound signal by mixing a direct sound signal picked up by a two-channel method from a sound source in an original sound field and a reverberation sound signal picked up by binaural sound pickup has been proposed (see Japanese Unexamined Patent Application Publication No. 6-217400).

A head-related transfer function, which indicates propagation characteristics from the position of the sound source to the ears of the listener in the binaural sound pickup described above, is measured by using the sound source direction (angle) as a parameter.

However, since such a head-related transfer function depends on the head shape and the pinna shape, it differs for each listener. In particular, since the characteristics of the high frequency band have large individual differences, a head-related transfer function that applies to many persons cannot be realized over a wide band.

In order to improve the quality of the reproduction sound image when a sound signal picked up by binaural sound pickup is reproduced, theoretically speaking, it is necessary to optimize the sound pickup apparatus for each listener. More specifically, since the head-related transfer function needs to be measured for each listener and optimized, a sound pickup device that is commercially practical for the general public cannot be constructed.

Accordingly, in order for the head-related transfer function to apply to many listeners, it is considered that superposition is performed by permitting a certain degree of error in order to generalize the head-related transfer function. However, if the head-related transfer function is generalized over a wide band, there is a risk of the sound localization of the stereophonic sound becoming unstable, and the sound image that should originally be perceived as a front sound image is mistakenly perceived as a back sound image, that is, so-called reverse front/back mis-perception occurs.

Variations in the above-described head-related transfer function occur due to variations of the head shape and the pinna shape of the listener and due to the relationship with the wavelength of sound waves that arrive from the sound source. For this reason, variations in the head-related transfer function for each listener are small for the low frequency components and are large for the high frequency components. Therefore, if, during sound pickup, an upper limit is provided for the sound band in which sound is picked up and the sound pickup is performed by targeting only the low frequency components, the head-related transfer function can be generalized. However, in that case, there is a drawback in that an unnatural sound having no high frequency components is generated.

As described above, in the conventional binaural sound pickup, since a head-related transfer function is difficult to generalize (standardize), it is not possible to provide a target sensation of sound localization with a natural sound to a large number of listeners.

Accordingly, the present invention has been made in view of the above-described points. An object of the present invention is to provide a sound pickup apparatus capable of providing a target sensation of sound localization to listeners by using a standard head-related transfer function, a sound pickup method for use with the sound pickup apparatus, and a recording medium having recorded thereon sound signals recorded by the sound pickup apparatus and the sound pickup method.

To achieve the above-mentioned object, in one aspect, the present invention provides a sound pickup apparatus including: extraction means for extracting low frequency components from an input signal having a head-related transfer function; delay means for delaying at least high frequency components of the input signal; and combining means for combining the low frequency components extracted by the extraction means and the high frequency components delayed by the delay means.

In another aspect, the present invention provides a sound pickup method comprising the steps of: extracting low frequency components from an input signal having a head-related transfer function; delaying at least high frequency components of the input signal; and combining the low frequency components and the high frequency components.

According to the present invention described above, high frequency components of the input signal having a head-related transfer function are delayed by the delay means, and the delayed high frequency components and the low frequency components extracted by the extraction means are combined by the combining means. Thus, a sound signal in which the low frequency components of the input signal come first in time can be obtained.

In another aspect, the present invention provides a sound pickup apparatus including: extraction means for extracting low frequency components from a sound source signal; delay means for delaying at least high frequency components of the sound source signal; combining means for combining the low frequency components extracted by the extraction means and the high frequency components delayed by the delay means; and head-related transfer function providing means for providing a predetermined head-related transfer function to at least the low frequency components of the sound source signal.

In another aspect, the present invention provides a sound pickup method including the steps of: extracting low frequency components from a sound source signal; delaying at least high frequency components of the sound source signal; combining the low frequency components and the high frequency components; and providing a predetermined head-related transfer function to at least the low frequency components of the sound source signal.

According to the present invention described above, high frequency components of the input signal are delayed by the delay means. The delayed high frequency components and the low frequency components extracted by the extraction means are combined by the combining means. Also, a head-related transfer function is provided to the low frequency components of the input signal by the head-related transfer function providing means. Thus, a sound signal in which the low frequency components to which the head-related transfer function is provided come first in time can be obtained.

On the recording medium in accordance with the present invention, a sound signal is recorded in which the low frequency components are extracted from the input signal having a head-related transfer function, at least the high frequency components of the input signal are delayed, and also, the low frequency components and the high frequency components are combined.

Furthermore, on the recording medium in accordance with the present invention, a sound signal is recorded in which low frequency components are extracted from a sound source signal, at least high frequency components of the sound source signal are delayed, the low frequency components and the high frequency components are combined, and also, a head-related transfer function is provided to at least the low frequency components of the sound source signal.

According to the present invention, when a sound signal is picked up, for example, low frequency components having a standard head-related transfer function can be picked up earlier than the other frequency components. Therefore, if a sound signal that is picked up in this manner is reproduced, it is possible to enable a listener in a reproduction sound field to perceive a target sensation of sound localization even when a standard head-related transfer function is used.

### BRIEF DESCRIPTION OF THE DRAWINGS

FIGS. 1A and 1B are illustrations showing the relationship between the position of a sound source and the position of a sound image perceived by a listener in a sound field space;

FIG. 2 is an illustration of an example of sound pickup using a dummy head microphone;

FIGS. 3A and 3B are illustrations of precedence localization;

FIGS. 4A and 4B are illustrations of precedence localization;

FIG. 5 shows the configuration of a stereophonic sound reproduction signal generation filter;

FIG. 6 shows the configuration of a sound apparatus according to a first embodiment of the present invention;

FIG. 7 shows the configuration of a sound apparatus according to a second embodiment of the present invention;

FIG. 8 shows the configuration of a sound apparatus according to a third embodiment of the present invention;

FIGS. 9A and 9B show propagation paths from the position of a sound source to the left and right ears of a listener in an indoor space;

FIGS. 10A and 10B are illustrations showing changes in the incidence angle to ears according to the distance from the sound source;

FIGS. 11A and 11B show correspondence data tables of head diffraction transfer functions;

FIGS. 12A and 12B show propagation paths from the position of a sound source to the center position of a listener in an indoor space;

FIG. 13 is an illustration of a change in the incidence angle to the ears according to the distance from the sound source;

FIGS. 14A and 14B show correspondence data tables of head diffraction transfer functions;

FIG. 15 shows another configuration of the sound apparatus according to this embodiment;

FIG. 16 shows another configuration of the sound apparatus according to this embodiment;

FIG. 17 shows another configuration of the sound apparatus according to this embodiment;

FIG. 18 is a block diagram showing the configuration of an AV system;

FIG. 19 is a block diagram showing another configuration of the AV system; and

FIG. 20 shows an example of the structure of multiplexed data from a sound source.

### DETAILED DESCRIPTION OF THE PREFERRED EMBODIMENTS

A sound apparatus according to an embodiment of the present invention will now be described below. Before the sound pickup apparatus according to this embodiment is described, the relationship between physical sound information and sound phenomena perceived subjectively by a listener, and properties of the sense of hearing regarding sound image perception of a human being are described.

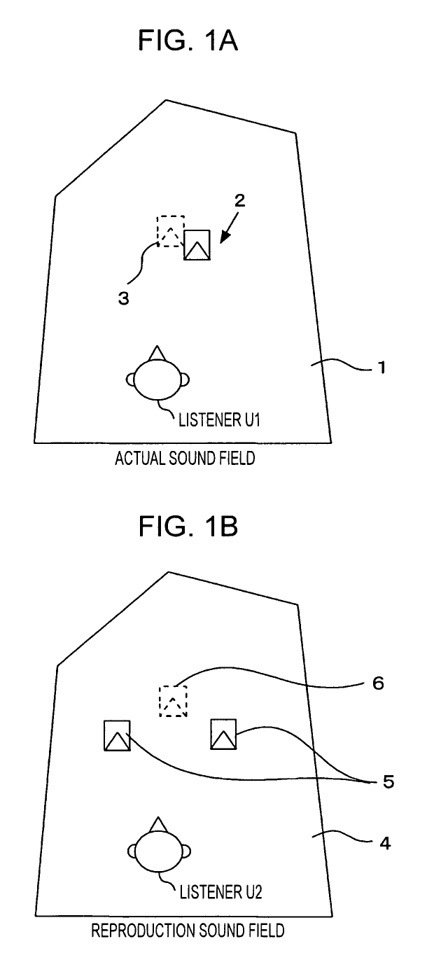

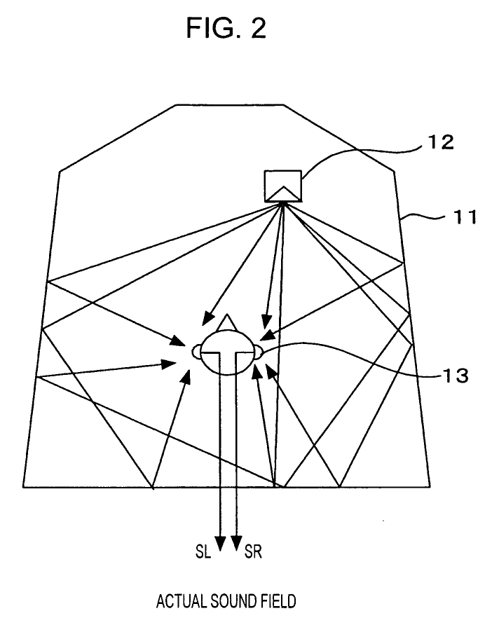

First, a description will be given, with reference to FIGS. 1A and 1B and FIG. 2, of the relationship between physical sound information (sound field information) and sound phenomena (perception of the sound image position, etc.) perceived subjectively by a listener.

FIGS. 1A and 1B are illustrations showing the relationship between the position of a sound source and the position of a sound image perceived by a listener in a sound field space. FIG. 1A shows the relationship between the position of a sound source and the position of a perceptual sound image perceived by a listener in an actual sound field. FIG. 1B shows the relationship between the playback position and the position of a perceptual sound image perceived by a listener in a reproduction sound field.

In general, when there is a sound source in a sound field space regardless of the actual sound field and the reproduction sound field, often, the perceptual sound image position perceived by the listener differs from the physical sound image position. For example, when an actual sound source 2 is arranged in an actual sound field space 1 of an actual sound field shown in FIG. 1A, there are cases in which the position of a perceptual sound image 3 perceived by a listener U1 differs from the position of the actual sound source 2.

When two playback speakers 5 and 5 are arranged as the reproduction sound source in a reproduction sound field space 4 shown in FIG. 1B, there are cases in which a perceptual sound image 6 is perceived by a listener U2 at the position indicated by the broken line.

This can be attributed to the fact that a physical clue for a listener to perceive the sound image position in a sound field space is sound obtained at the two ears of the listener (binaural sound) and that the boundary connecting together the acoustic physical space and the subjective psychological space is sound signals at the two ears. Therefore, if, by using some kind of means, sound, shown in FIG. 1A, which is the same as that heard by the listener U1 in the actual sound field, can be reproduced in a reproduction sound field shown in FIG. 1B, it is considered that the listener U2 in the reproduction sound field can perceive the same sound image as that in the actual sound field. With such an idea, as a microphone, a dummy head microphone is known for the purpose of picking up sound at positions of the two ears of the listener. The dummy head microphone is configured by mounting microphones at positions of the two ears of a dummy head produced by imitating, for example, the shape and the size of the head and the pinna of a human being.

FIG. 2 is an illustration of an example of sound pickup using a dummy head microphone. As shown in FIG. 2, when sound pickup is performed using a dummy head microphone 13, originally, the dummy head microphone 13 is arranged at a position where the listener should listen in an actual sound field space 11, and direct sound that directly arrives from an actual sound source 12 and reflected sound that is reflected at a wall, a floor, a ceiling, etc., is picked up using microphones mounted on the corresponding two ear positions of a dummy head. Then, the sounds picked up by the individual microphones are output as a signal SL for the left ear and a signal SR for the right ear.

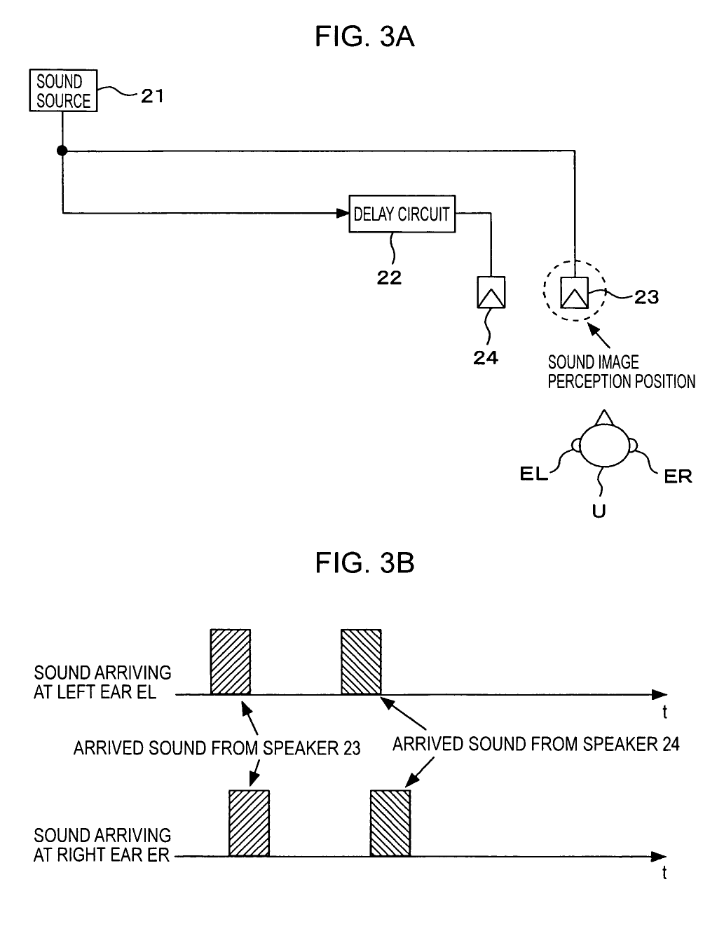

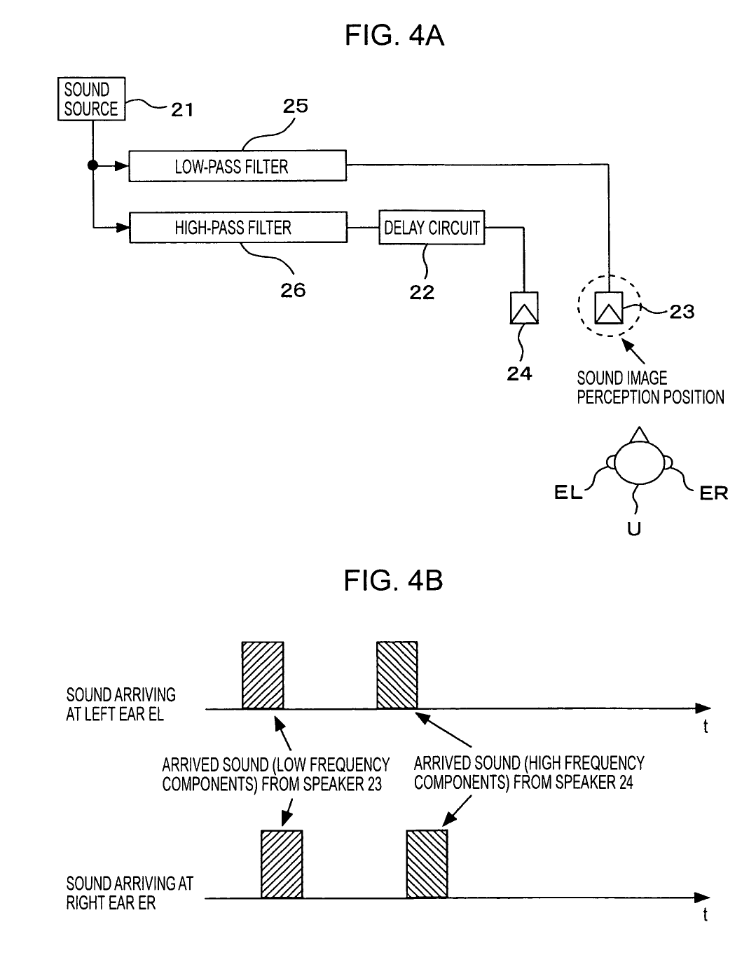

Next, a description will be given, with reference to FIGS. 3A and 3B and FIGS. 4A and 4B, of properties of the sense of hearing regarding the sound image perception of a human being.

The sense of hearing of a human being has properties such that, among sounds originating from the same sound source, the sound image is localized in the direction of the sound that arrives earlier at the ears of the listener. Such properties of a human being are described with reference to FIGS. 3A and 3B.

First, a sound apparatus shown in FIG. 3A is considered. In this case, a sound source signal from a sound source 21 is output as is as a reproduction sound from a speaker 23. Furthermore, a signal such that a sound source signal from the sound source 21 is delayed by a delay circuit 22 is output as a reproduction sound from a speaker 24.

At this time, the reproduction sound arrives at a listener U who listens at a position shown in FIG. 3A at a timing shown in FIG. 3B. That is, first, the reproduction sound of the speaker 23 arrives at a left ear EL of the listener U. Also, the reproduction sound of the speaker 23 arrives at a right ear ER of the listener U at a timing that is slightly later than that of the left ear EL of the listener U. Furthermore, the reproduction sound of the speaker 24 arrives at the left ear EL of the listener U at a timing that is delayed by a delay time due to the delay circuit 22, and the reproduction sound of the speaker 24 arrives at the right ear ER of the listener U at a timing that is slightly later than the above timing for the left ear. In this case, the position of the sound image perception of the listener U, shown in FIG. 3A, becomes the position of the speaker 23, at which the reproduction sound arrives earlier.

The inventors of the present invention have made further studies on the properties of the sense of hearing and have found the following fact. The sense of hearing of a human being separates sound originating from the same sound source into low frequency components and high frequency components, and causes information on the direction of the sound source to be contained in the low frequency components, and if the low frequency components are output earlier, the listener can be made to clearly perceive the sound localization even if the information of the sound source direction contained in the high frequency components is not accurate.

Such properties of the sense of hearing of a human being are described with reference to FIGS. 4A and 4B. In the sound apparatus shown in FIG. 4A, a low-pass filter 25 is provided between the sound source 21 and the speaker 23. Thus, only the sound source signal that passes through the low-pass filter 25 is output as a reproduction sound from the speaker 23.

On the other hand, since a high-pass filter 26 and a delay circuit 22 are provided between the sound source 21 and the speaker 24, from the speaker 24, only the signal such that the sound source signal of the high frequency components that pass through the high-pass filter 26 is delayed by the delay circuit 22 is output as a reproduction sound.

At this time, the reproduction sound arrives at the listener U who listens at a position shown in FIG. 4A at a timing shown in FIG. 4B. That is, the reproduction sound (the low frequency components) of the speaker 23 arrives at the left ear EL of the listener U. Also, the reproduction sound of the speaker 23 arrives at the right ear ER of the listener U at a timing slightly later than that of the left ear EL of the listener U. Furthermore, the reproduction sound (the high frequency components) of the speaker 24 arrives at the left ear EL of the listener U at a timing delayed by the delay time due to the delay circuit 22, and the reproduction sound of the speaker 24 arrives at the right ear ER of the listener U at a timing slightly delayed from the above timing for the left ear. In this case, the position of the sound image perception of the listener U, shown in FIG. 4A, becomes the position of the speaker 23, at which the reproduction sound (the high frequency components) arrives earlier at the listener U. Thus, it can be seen that it is possible to enable the listener U to clearly perceive the sound image with respect to the sound of the sound source, which is the same as the reproduction sound (the low frequency components) from the speaker 23, which arrives earlier at the listener U.

In a conventional stereo reproduction system using an intensity-based method, for example, reproduction sound that is played back from the left speaker arrives at not only the left ear of the listener, but also the right ear. For this reason, when the sound signal picked up by the dummy head microphone is played back by a stereo reproduction system using an intensity-based method, a signal SL for the left ear and a signal SR for the right ear, which are picked up by the dummy head microphone 13 shown in FIG. 2, arrive not only at the corresponding left and right ears of the listener, but also at the ears on the opposite sides.

Accordingly, when the signal for the left ear and the signal for the right ear, which are picked up by the dummy head microphone, are to be played back by a two-channel stereo reproduction system, a stereophonic sound reproduction signal generation filter is known as a filter capable of playing back the signal input to the left speaker at only the left ear of the listener and capable of playing back the signal input to the right speaker at only the right ear of the listener.

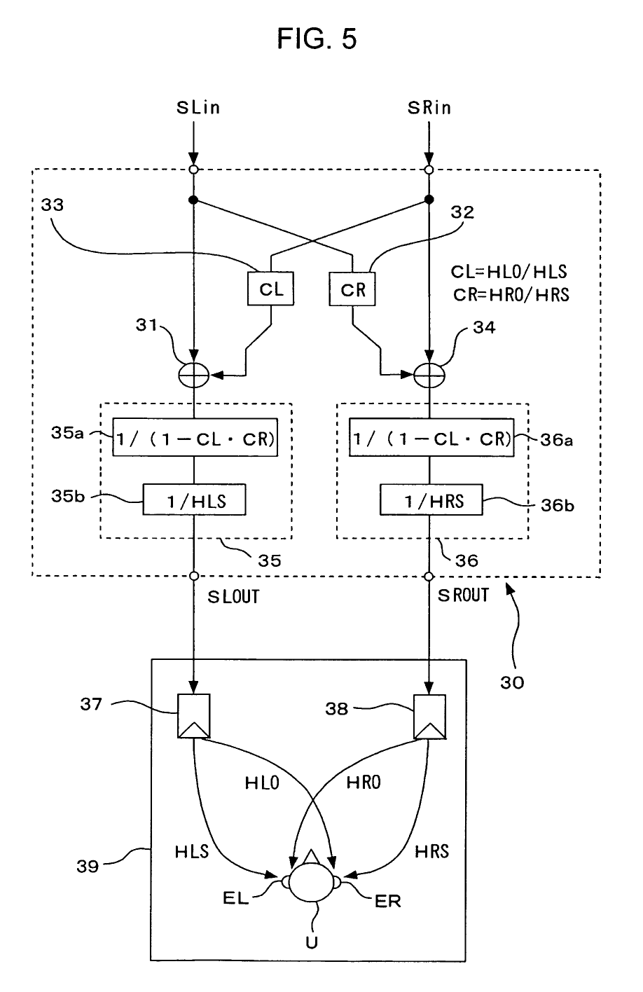

FIG. 5 shows the configuration of a stereophonic sound reproduction signal generation filter. In FIG. 5, a description is given by using as an example a case in which a speaker is arranged to the left and to the right in the front of the listener U.

In FIG. 5, a head diffraction transfer function of a path that starts from a left speaker 37 and that reaches the left ear EL of the listener U in a reproduction sound field space 39 is denoted as HLS, and a head diffraction transfer function of a path that starts from a right speaker 38 and that reaches the right ear ER of the listener U is denoted as HRS. Furthermore, a head diffraction transfer function of a path that starts from the left speaker 37 and that reaches the right ear ER of the listener U is denoted as HL0, and a head diffraction transfer function of a path that starts from the right speaker 38 and that reaches the left ear EL of the listener U is denoted as HR0.

In a stereophonic sound reproduction signal generation filter 30 shown in FIG. 5, a signal SLin for the left ear from the dummy head microphone (not shown in FIG. 5) is input to an adder 31 and a crosstalk canceling section 32. A signal SRin for the right ear from the dummy head microphone (not shown) is input to an adder 34 and a crosstalk canceling section 33.

In this case, propagation characteristics CR of the crosstalk canceling section 32 are denoted as −HRO/HRS, and a canceling signal that passes through the crosstalk cancel section 32 is input as a canceling signal to the adder 34. Propagation characteristics CL of the crosstalk canceling section 33 are denoted as −HLO/HLS, and a canceling signal that passes through the crosstalk canceling section 33 is input to the adder 31.

The adder 31 adds together the input signal SLin for the left ear and the canceling signal, and outputs the signals. The output of the adder 31 is supplied to a correction block section 35. The adder 34 adds together the signal SRin for the right ear and the canceling signal from the crosstalk canceling section 32, and supplies the signals to a correction block section 36.

The correction block section 35 is a block section for correcting the reproduction system, including the left speaker 37, with respect to the left channel. The correction block section 35 is formed by a correction section 35a for correcting changes of the characteristics, which occur due to the crosstalk canceling section, and a speaker correction section 35b for correcting speaker characteristics. The propagation characteristics of the correction section 35a are denoted as 1/(1−CL·CR). The propagation characteristics of the correction section 35b are denoted as 1/HLS. The output of the correction block section 35 is output as a signal SLout for the left ear from the stereophonic sound reproduction signal generation filter 30.

The correction block section 36 is a block section for correcting the reproduction system, including the right speaker 38, with respect to the right channel. The correction block section 36 is formed by a correction section 36a for correcting changes of the characteristics, which occur due to the crosstalk canceling section, and a speaker correction section 36b for correcting speaker characteristics. The propagation characteristics of the correction section 36a are denoted as 1/(1−CL·CR). The propagation characteristics of the correction section 36b are denoted as 1/HRS. The output of the correction block section 36 is output as a signal SRout for the right ear from the stereophonic sound reproduction signal generation filter 30.

Then, the signal SLout for the left ear, which is output from the stereophonic sound reproduction signal generation filter 30, is input to the left speaker 37 in the reproduction sound field space 39, and the signal SRout for the right ear is input to the right speaker 38 in the reproduction sound field space 39. As a result, at the left ear EL of the listener U in the reproduction sound field space, only the left ear sound corresponding to the signal SLin for the left ear, which is input to the stereophonic sound reproduction signal generation filter 30, can be reproduced. At the right ear ER of the listener U, similarly, only the right ear sound corresponding to the signal SRin for the right ear, which is input to the stereophonic sound reproduction signal generation filter 30, can be reproduced.

Here, since the head-related transfer function of a human being differs for each listener, which has been conventionally problematical, strictly speaking, a dummy head microphone needs to be provided for each listener. Furthermore, since the head diffraction transfer functions HLS, HL0, HRs, and HR0 depend strongly on the listener, it is necessary to measure the head-related transfer function for each individual in order to provide the best sound image quality to the listener. However, in practice, since sound pickup is performed by using a dummy head microphone having standard characteristics of a head diffraction transfer function, satisfactory sound image quality cannot be provided.

However, there are hardly any differences between the sound characteristics for each listener and the standard sound characteristics determined by directional characteristics and a head-related transfer function of a standard dummy head microphone up to approximately 1 kHz, but the differences tend to increase at approximately 3 kHz or higher.

Based on the description up to this point, a sound apparatus according to the present embodiment is described below.

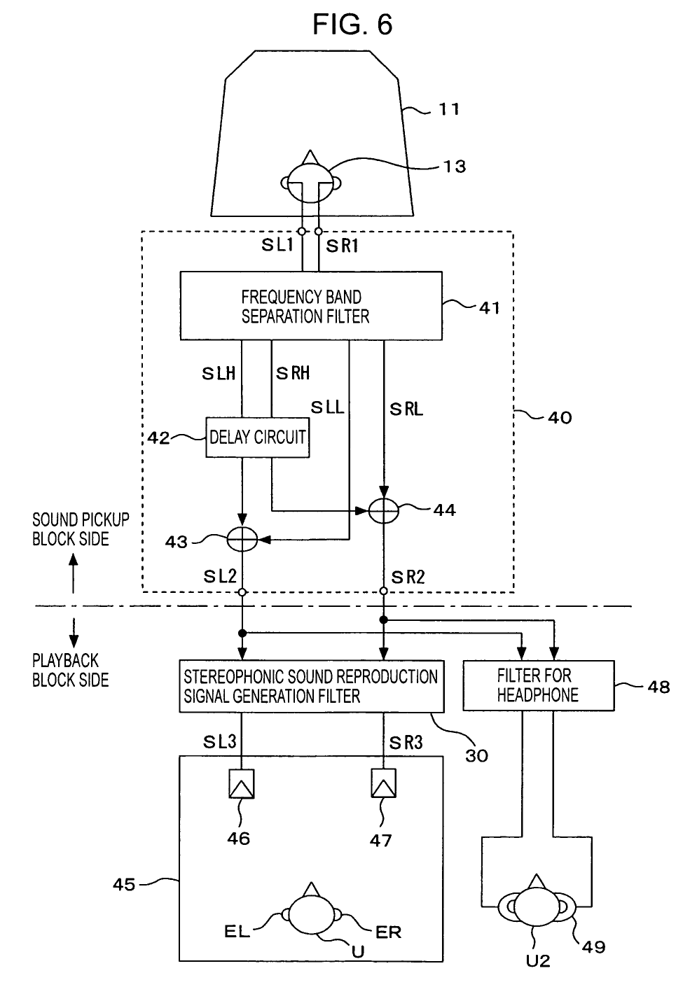

FIG. 6 shows the configuration of a sound apparatus according to a first embodiment of the present invention. The sound apparatus shown in FIG. 6 is formed of a sound pickup block, which is a sound pickup apparatus, and a playback block. The sound pickup block is formed by the dummy head microphone 13 and a microphone amplifying section 40 arranged in the actual sound field space 11. In the sound pickup block, sound is picked up by the dummy head microphone 13, and a signal SL1 for the left ear and a signal SR1 for the right ear, which are converted into electrical signals, are input to the microphone amplifying section 40 enclosed by the broken line.

The microphone amplifying section 40 includes a frequency band separation filter 41, a delay circuit 42, and adders 43 and 44.

The frequency band separation filter 41 separates the signal SL1 for the left ear and the signal SR1 for the right ear, which are input from the dummy head microphone 13, into corresponding signals of low frequency components (low frequency signals) SLL and SRL, and signals of high frequency components (high frequency signals) SLH and SRH with, for example, approximately 3 kHz being set as a boundary. The reason for setting the boundary frequency to 3 kHz in this embodiment is that the error between the standard dummy head microphone 13 and the head diffraction transfer function of the listener begins to increase from approximately 1 kHz, further increases when exceeding approximately 3 kHz, and the fundamental frequency components of speech, musical instrument sounds, etc., are contained within 3 kHz at the highest.

The boundary frequency of the frequency band separation filter 41 needs not always to be set to 3 kHz, and may be set to any frequency between, for example, 1 kHz and 3 kHz.

The high frequency signal SLH for the left ear and the high frequency signal SRH for the right ear, which are separated by the frequency band separation filter 41, are input to the delay circuit 42. In the delay circuit 42, the high frequency signal SLH for the left ear and the high frequency signal SRH for the right ear, which are input, are delayed by a set delay time and are output.

In this case, the high frequency signal SLH for the left ear and the high frequency signal SRH for the right ear in the delay circuit 42 are output by being delayed by several milliseconds to several tens of milliseconds from the output timing of the low frequency signal SLL for the left ear and the low frequency signal SRL for the right ear. However, such a delay time needs only to be set within a time in which the high tone range that is finally played back by being delayed is not heard as echo sound of a low tone range to the listener U.

The adder 43 adds together the high frequency signal SLH for the left ear from the delay circuit 42 and the low frequency signal SLL for the left ear from the frequency band separation filter 41. Then, the added output of the adder 43 is output as a signal SL2 for the left ear from the sound pickup block to the playback block.

The adder 44 adds together the high frequency signal SRH for the right ear from the delay circuit 42 and the low frequency signal SRL for the right ear from the frequency band separation filter 41. Then, the added output of the adder 44 is output as a signal SR2 for the right ear from the sound pickup block to the playback block.

Here, when the playback block is formed of speakers of two channels, the signal SL2 for the left ear and the signal SR2 for the right ear output from the microphone amplifying section 40 of the sound pickup block are input to the corresponding speakers 46 and 47 via the stereophonic sound reproduction signal generation filter 30 shown in FIG. 5.

Therefore, according to the sound apparatus configured in this manner, the left ear sound picked up at the position of the left ear of the dummy head microphone 13 arranged in the actual sound field space 11 can be reproduced at only the left ear EL of the listener U in a reproduction sound field space 45. Furthermore, the right ear sound picked up at the position of the right ear of the dummy head microphone 13 can be reproduced at only the right ear ER of the listener U.

On the other hand, when the playback block is formed of a headphone, the signal SL2 for the left ear and the signal SR2 for the right ear output from the microphone amplifying section 40 of the sound pickup block are input to a headphone 49 via a filter 48 for a headphone. For the filter 48 for a headphone, a filter for making corrections in accordance with the characteristics of the headphone 49 is used.

In this case, at the left ear EL of the listener U2 in which the headphone 49 is installed, only the left ear sound picked up at the position of the left ear of the dummy head microphone 13 in the actual sound field space 11 is reproduced. Furthermore, at the right ear ER of the listener U, only the right ear sound picked up at the position of the right ear of the dummy head microphone 13 is reproduced.

In addition, in the sound apparatus according to this embodiment, when the playback block performs either two-channel speaker playback or headphone playback, in the microphone amplifying section 40 of the sound pickup block, only the high frequency components of the signal SL1 for the left ear and the signal SR1 for the right ear input from the dummy head microphone 13 are delayed by the delay circuit 42. That is, in this embodiment, only the high frequency components in which the influence of the head-related transfer function for which the individual differences are large tends to appear as sound image perception are delayed by the sound pickup block.

Therefore, according to the sound apparatus shown in FIG. 6, when the playback block performs either two-channel speaker playback or headphone playback, since the reproduction sound of the low frequency components for which the individual differences are small is output earlier from the speaker, it becomes possible for the listener U in a reproduction sound field space 45 to perceive the sensation of sound localization by the reproduction sound of the low frequency components that arrive earlier.

More specifically, according to the sound apparatus of this embodiment, since the influence of the individual differences with respect to the sound image perception can be reduced, even when a standard head-related transfer function is used, it is possible to enable the listener U to perceive a target sensation of sound localization, for example, a sensation of sound localization as if the listener in the reproduction sound field space 45 is in the actual sound field space 11.

Although the embodiment has been discussed above by assuming that the delay circuit 42 is provided independently in the sound apparatus shown in FIG. 6, the delay circuit 42 needs not always to be provided independently. For example, the delay circuit 42 may also be configured by using the phase delay characteristics of the frequency band separation filter 41.

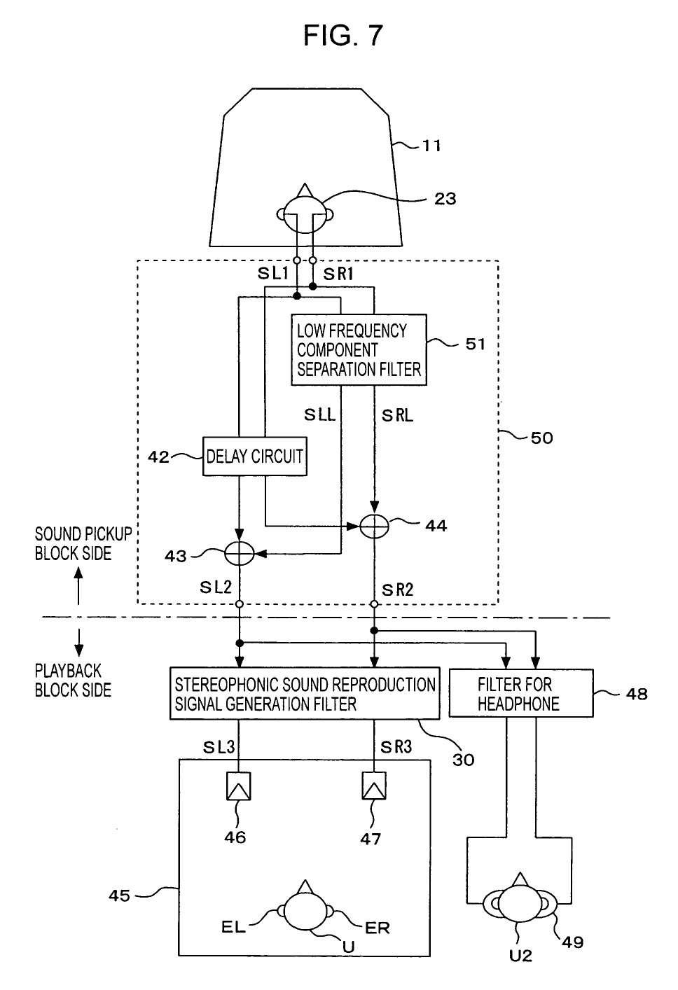

FIG. 7 shows the configuration of a sound apparatus according to a second embodiment of the present invention. Components of the sound apparatus in FIG. 7, which are identical to the components of the sound apparatus shown in FIG. 6, are designated with the same reference numerals, and accordingly, detailed descriptions thereof are omitted. The sound apparatus shown in FIG. 7 differs from the sound apparatus shown in FIG. 6 in the configuration of a microphone amplifying section 50 provided in the sound pickup block.

In the microphone amplifying section 50 in this case, a signal SL1 for the left ear and a signal SR1 for the right ear, which are input from the dummy head microphone 13, are input to the delay circuit 42 and a low-pass filter 51.

In the low-pass filter 51, for example, only the low frequency components lower than or equal to 3 kHz are separated from the signal SL1 for the left ear and the signal SR1 for the right ear, which are input, and are output.

Although, in this embodiment, the frequency band that can be separated by the low-pass filter 51 is set to be lower than or equal to 3 kHz, this is only an example. Of course, the frequency band can be set to any frequency between, for example, 1 kHz to 3 kHz.

The low frequency signal SLL for the left ear output from the low-pass filter 51 is input to the adder 43. The low frequency signal SRL for the right ear output from the low-pass filter 51 is output to the adder 44.

In the adder 43, the signal SL1 for the left ear delayed by the delay circuit 42 and the low frequency signal SLL for the left ear from the frequency band separation filter 41 are added together, and the added output is output as a signal SL2 for the left ear. In the adder 44, the signal SR1 for the right ear delayed by the delay circuit 42 and the low frequency signal SRL for the right ear from the frequency band separation filter 41 are added together, and the added output is output as a signal SR for the right ear from the sound pickup block to the playback block.

More specifically, the microphone amplifying section 50 of the sound apparatus shown in FIG. 7 is such that, in place of the frequency band separation filter 41 provided in the microphone amplifying section 40 shown in FIG. 6, the low-pass filter 51 for separating only the low frequency components is provided.

Therefore, also, in the sound apparatus shown in FIG. 7, when the playback block performs either two-channel speaker playback or headphone playback, since the reproduction sound of the low frequency components is output earlier from the speaker, it becomes possible to enable the listener U in a reproduction sound field space 45 to perceive the sensation of sound localization by the reproduction sound of the low frequency components that arrive earlier. That is, similarly to the sound apparatus shown in FIG. 6, even when the standard head-related transfer function is used, it is possible to enable the listener U in the reproduction sound field space 45 to perceive the target sensation of sound localization.

In the sound apparatus shown in FIGS. 6 and 7, binaural sound pickup is performed from the actual sound field space 11 by using the dummy head microphone 13. However, this is only an example, and even if, for example, microphones are installed at both ears of a human being in place of a dummy head, binaural sound pickup can be performed in a similar manner.

In the sound apparatus described up to this point, by picking up the signal SL1 for the left ear and the signal SR1 for the right ear input to the sound pickup block by mounting a dummy head microphone or by mounting microphones at both ears of a human being, binaural sound pickup is performed. This is only an example, and, for example, it is also possible to use a sound source signal that is not picked up by binaural sound pickup.

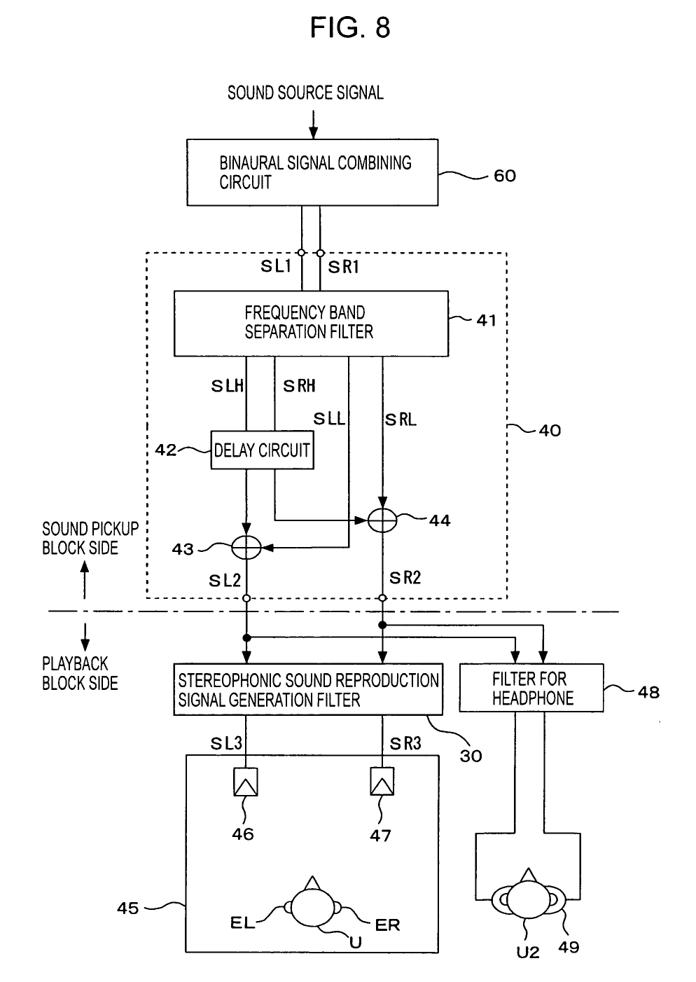

FIG. 8 shows the configuration of such a sound apparatus according to a third embodiment of the present invention. Components of the sound apparatus shown in FIG. 8, which are identical to the components of the sound apparatus shown in FIG. 6, are designated with the same reference numerals, and accordingly, detailed descriptions thereof are omitted. In the sound apparatus shown in FIG. 8, a binaural signal combining circuit 60 for obtaining the signals corresponding to the signal SL1 for the left ear and the signal SR1 for the right ear by performing a predetermined combining process on the input sound source signal is provided. The remaining construction is the same as that of the sound apparatus shown in FIG. 6.

In the binaural signal combining circuit 60, by superposing, on the sound source signal, the propagation characteristics for each propagation path of sound waves and the head-related transfer function for each incidence angle to the listening position in an indoor space, a signal in which the total sum for the propagation paths is a hearing sound is obtained.

The sound source signal in this case may be any of an audio signal of an existing source, an audio signal synthesized by an electronic musical instrument, etc. For the above audio method, any audio method, for example, a monaural method, a stereo method, and a surround method, may be used.

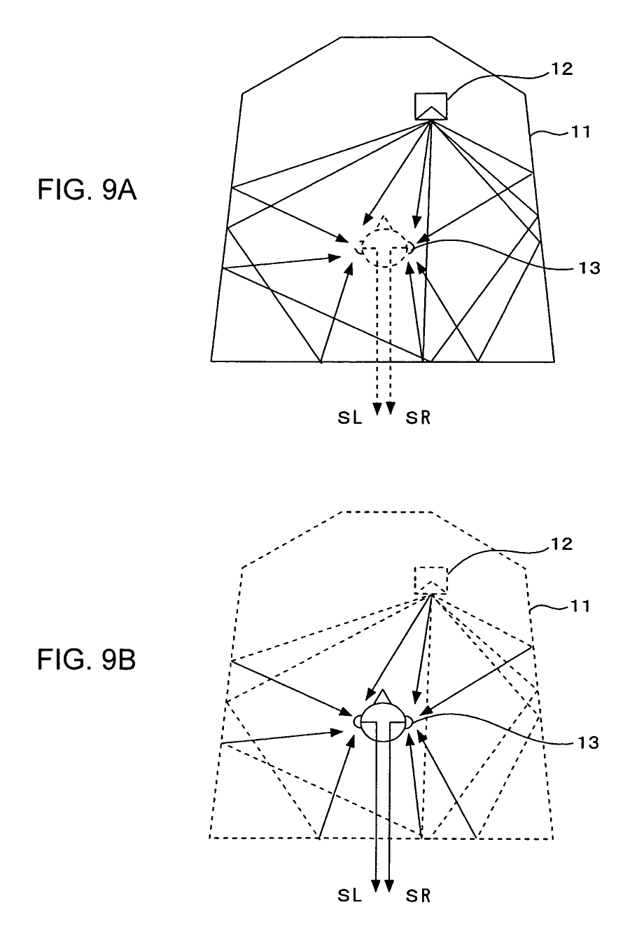

A description will now be given, with reference to FIGS. 9A and 9B to FIGS. 14A and 14B, of an example of a method for combining a signal for the left ear and a signal for the right ear in a binaural signal combining circuit.

In order to generate the signal for the left ear and the signal for the right ear in the binaural signal combining circuit 60, first, based on the shape of the acoustic space such as a concert hall, acoustic characteristics such as the sound reflection/absorption characteristics of the a wall surface, a floor, and a ceiling, and the radiation directional characteristics of the sound source, how the sound radiated from the sound source propagates in the indoor space needs to be computed.

More specifically, first, the shape of the acoustic space such as a concert hall, wall surface acoustic characteristics such as the sound reflection/absorption characteristics of a wall surface, a floor, and a ceiling, the sound source position, the radiation directional characteristics of the sound source, the listening point position, and the directional characteristics of the hearing microphone are input. Based on these inputs, the propagation characteristics of sound waves from the sound source to the listening point are computed.

FIG. 9A is a schematic view showing a propagation path from the position of the sound source to the left and right ears of the listener in an indoor space. As shown in FIG. 9A, in the actual sound field space 11, such as a concert hall, sound waves are reflected on the wall surface, the floor, the ceiling, etc., and arrive toward the listening position (in this case, the dummy head microphone 13 indicated by the broken line is arranged at the listening position) from various directions.

Here, in order to precisely compute the propagation of sound waves from the sound source 12 to the listening position, as indicated by the solid line in FIG. 9B, the direction (angle) of the sound source and the distance to the sound source when viewed from the dummy head microphone 13 are determined. Then, by superposing the head diffraction transfer function data determined by the direction of the sound source and the distance to the sound source on the sound source signal, the signals corresponding to the signal for the left ear and the signal for the right ear are determined.

For the above-described head diffraction transfer function data, the dummy head microphone 13 is arranged in advance at an actual listening position, the head diffraction transfer function data is measured at predetermined angle intervals, and the data is stored in a memory (not shown). When the head diffraction transfer function data is stored, the head diffraction transfer function data of the closest angle is extracted, and based on that data, the sound signals corresponding to the signal for the left ear and the signal for the right ear are determined by performing an interpolation process in accordance with the angle.

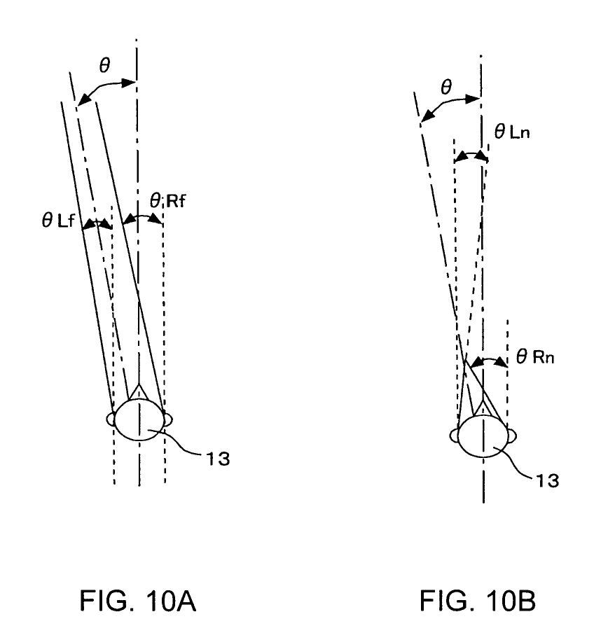

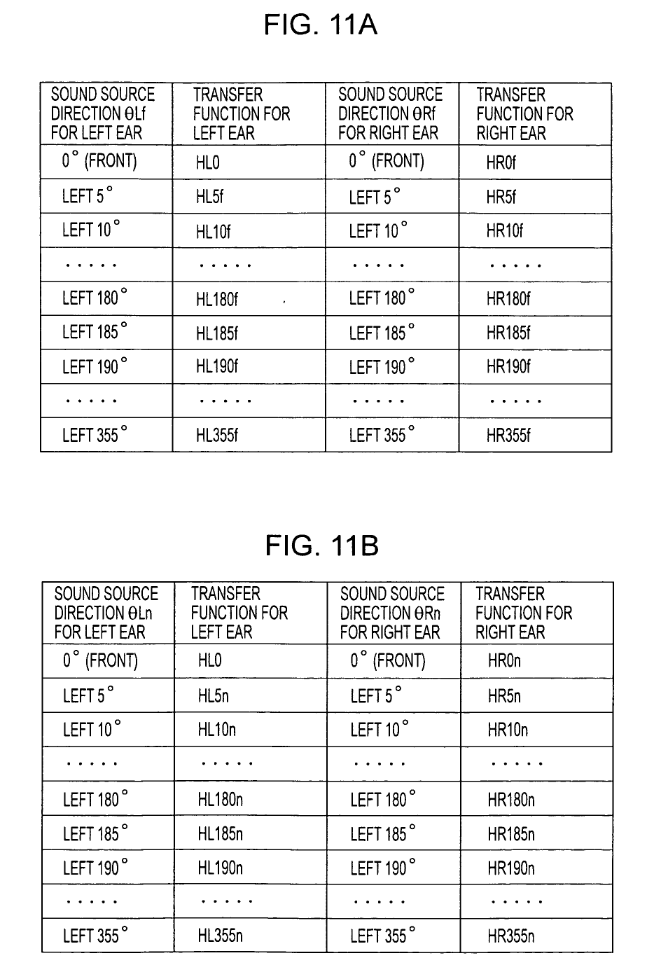

At this time, as shown in FIGS. 10A and 10B, when the distances from the left and right ears of the listener to the position of the sound source differ from each other, the incidence angle differs even if the direction θ of the sound source is the same. For example, as can be seen from the incidence angle θLf of the left ear and the incidence angle θRf of the right ear when the sound source exists at a position far from the listener shown in FIG. 10A, and the incidence angle θLn of the left ear and the incidence angle θRn of the right ear when the sound source exists at a position near the listener shown in FIG. 10B, the incidence angle differs. For this reason, for example, the direction of a far sound source and the head diffraction transfer function data for the left and right ears shown in FIG. 11A, and the direction of a near sound source and the head diffraction transfer function data for the left and right ears shown in FIG. 11B are provided.

If there is no limitation on the storage capacity of the memory in which the above-described correspondence data can be stored, the head diffraction transfer function data, in which the distance from the listening position to the sound source and the direction of the sound source are parameters, can also be stored in the memory.

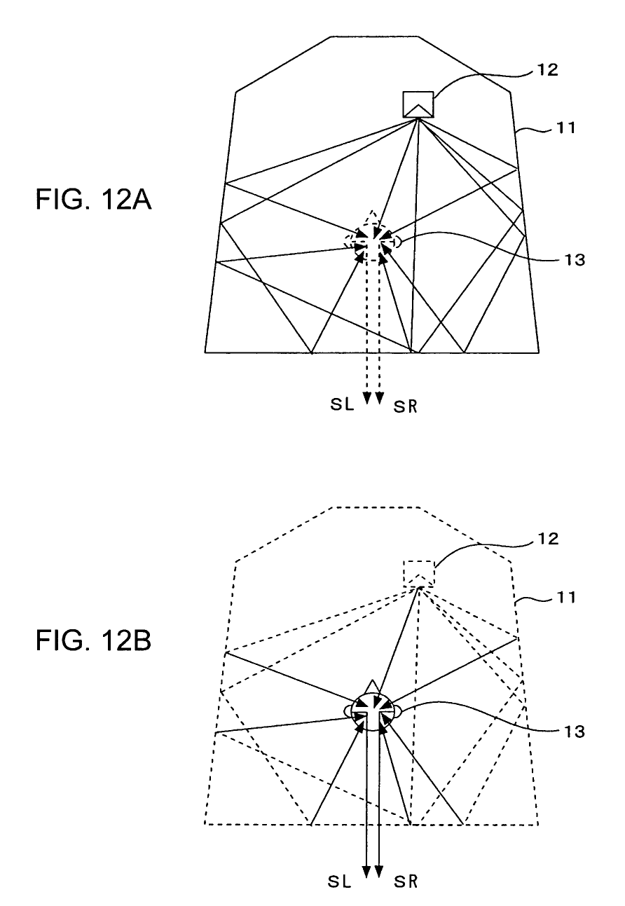

FIG. 12A is a schematic view showing a propagation path from the position of the sound source to the center position of the listener at the listening position in an indoor space. Also, in this case, sound waves arrive at the dummy head microphone 13 at the listening position from various directions.

Also, in this case, in order to precisely compute the propagation of sound waves from the sound source 12 to the dummy head microphone 13 at the listening position, as indicated by the solid line in FIG. 12B, the direction (angle) of the sound source and the distance to the sound source when viewed from the dummy head microphone 13 are determined, and by superposing the head diffraction transfer function data determined by the direction of the sound source and the distance to the sound source on the sound source signal, the signals corresponding to the signal for the left ear and the signal for the right ear are determined.

Also, in this case, for the head diffraction transfer function data, the dummy head microphone 13 is arranged at an actual listening position and the data is measured, or the head diffraction transfer function data is measured in advance at predetermined angle intervals, and the data is stored in the memory. When the head diffraction transfer function data is stored in the memory, the head diffraction transfer function data of the closest angle is extracted, and based on that data, the sound signals corresponding to the signal for the left ear and the signal for the right ear are determined by performing an interpolation process in accordance with the angle.

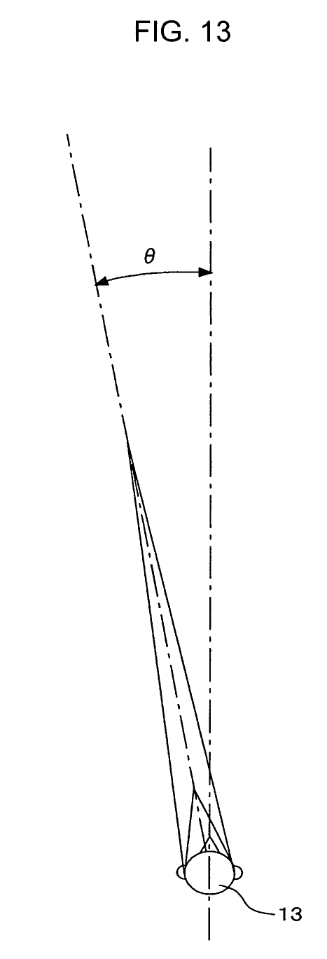

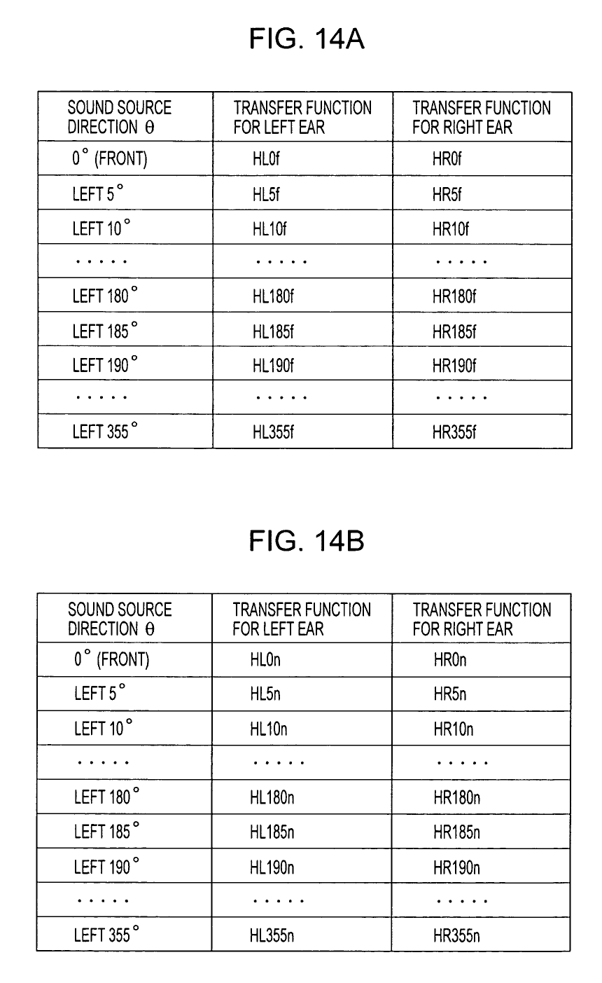

At this time, as shown in FIG. 13, when the distance from the center position of the listener to the sound source differs, the head diffraction transfer function data from the listening position to the sound source differs even if the sound source direction θ is the same similarly to that described above. For this reason, for example, the head diffraction transfer function data for a far distance shown in FIG. 14A and the head diffraction transfer function data for a near distance shown in FIG. 14B needs only to be provided.

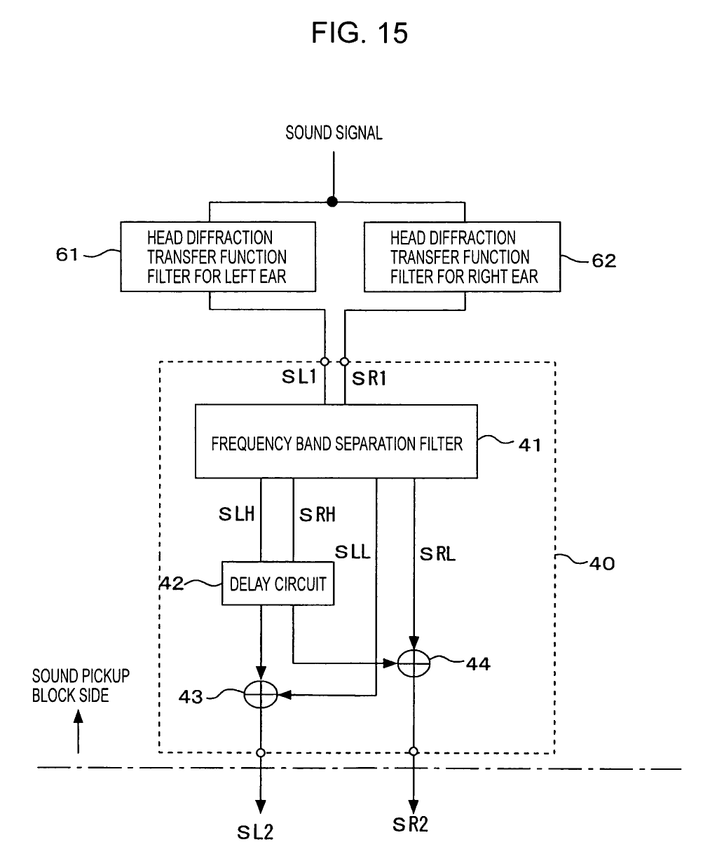

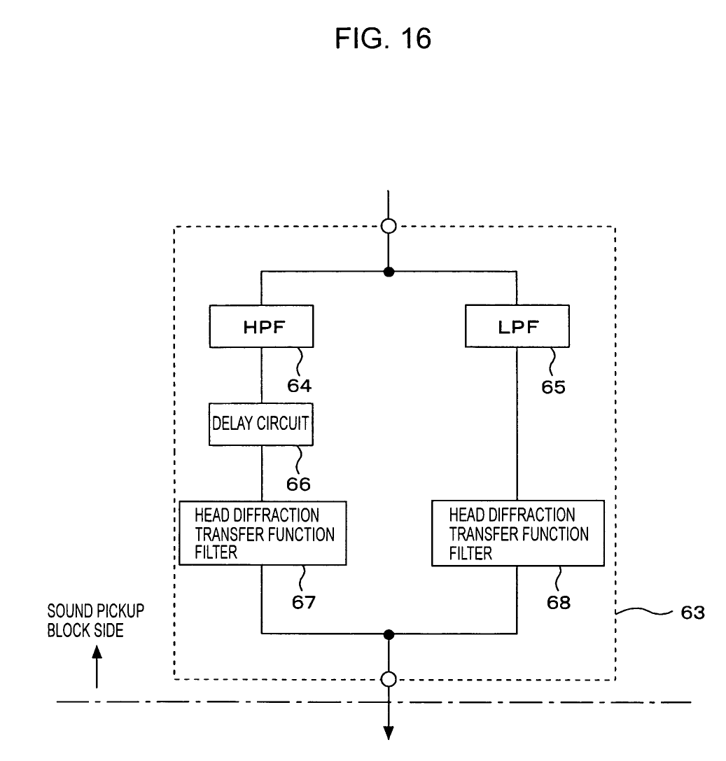

The sound pickup block of the sound apparatus according to this embodiment may be configured in another way. FIGS. 15 and 16 show other examples of the configuration of the sound pickup block of the sound apparatus according to this embodiment.

The sound pickup block shown in FIG. 15 is provided with a head diffraction transfer function filter 61 for the left ear for providing a head-related transfer function for the left ear to the input sound source signal and a head diffraction transfer function filter 62 for the right ear for providing a head diffraction transfer function for the right ear to the input sound source signal, so that the signal SL1 for the left ear is obtained by the head diffraction transfer function filter 61 for the left ear, and the signal SR1 for the right ear is obtained by the head diffraction transfer function filter 62 for the right ear. Then, the signal SL1 for the left ear and the signal SR1 for the right ear, which are obtained in this manner, are input to the microphone amplifying section 40.

In the sound pickup block shown in FIG. 16, in a microphone amplifying section 63, high frequency components that pass through a high-pass filter (HPF) 64 from among the input sound source signals are input to a delay circuit 66, the high frequency components are delayed by a predetermined time by the delay circuit 66, and thereafter the high frequency components are input to a head diffraction transfer function filter 67.

On the other hand, low frequency components that pass through a low-pass filter (LPF) 65 from among the input sound source signals are input as is to a head diffraction transfer function filter 68. Then, in the head diffraction transfer function filters 67 and 68, the respective components are output with a head diffraction transfer function being provided.

Therefore, even when the sound apparatus is configured as shown in FIGS. 15 and 16, since only the high frequency components contained in the sound source signal are delayed by a predetermined time by the delay circuit 66, the low frequency components of the sound source signal can be reproduced earlier. As a result, it becomes possible for the listener in a reproduction sound image to perceive the sensation of sound localization by the reproduction sound of the low frequency components that arrive earlier.

In the sound pickup block shown in FIG. 16, the HPF 64 is provided, but the HPF 64 needs not always to be provided. Even if the input sound source signal is delayed by a predetermined time by the delay circuit 66, it becomes possible for the listener in the reproduction sound field to perceive the sensation of sound localization by the reproduction sound of the low frequency components that arrive earlier. Furthermore, for listening, since the sensation of sound localization can be perceived by the reproduction sound of the low frequency components that arrive earlier, it is possible to omit the head diffraction transfer function filter 67 provided on the high frequency side.

In the sound apparatus described up to this point, a description has been given by using as an example a case in which the signal for the left ear and the signal for the right ear, which are picked up by the sound pickup block, are played back by a two-channel speaker and a headphone. Alternatively, for example, the signal for the left ear and the signal for the right ear, which are picked up by the sound pickup block, can also be recorded on a recording medium, such as an optical disc.

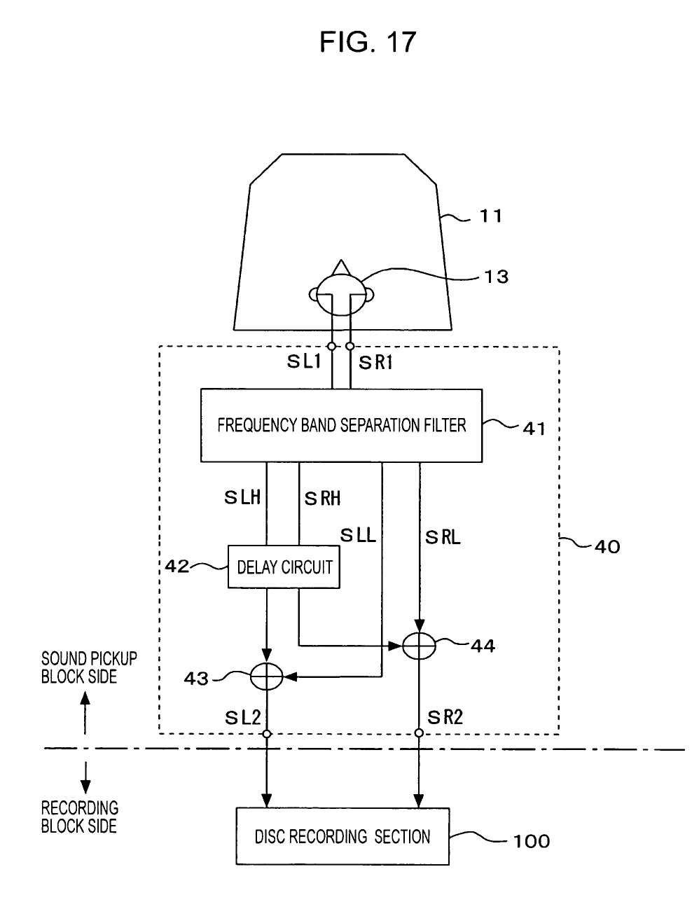

FIG. 17 is a block diagram showing the configuration of such a sound apparatus. Since the components of the sound pickup block of the sound apparatus are identical to that of the sound apparatus shown in FIG. 6, descriptions thereof are omitted.

The sound apparatus shown in FIG. 17 is formed of a sound pickup block and a recording block. The recording block is provided with a disc recording section 100 for recording data on a recording medium such as an optical disc.

The disc recording section 100 operates, for example, to code an analog signal SL2 for the left ear and an analog signal SR2 for the right ear from the sound pickup block, convert them into data for the left ear and data for the right ear, and thereafter adds channel header data to the corresponding data so as to be formed as data for audio channels.

Then, after the data for audio channels is multiplexed, by adding a packet header, an audio packet is formed. Thereafter, the audio packet is recorded on a recording medium, or multiplexed data in which a subtitle packet, a video packet, and a pack header are multiplexed together with the audio packet is recorded on a recording medium.

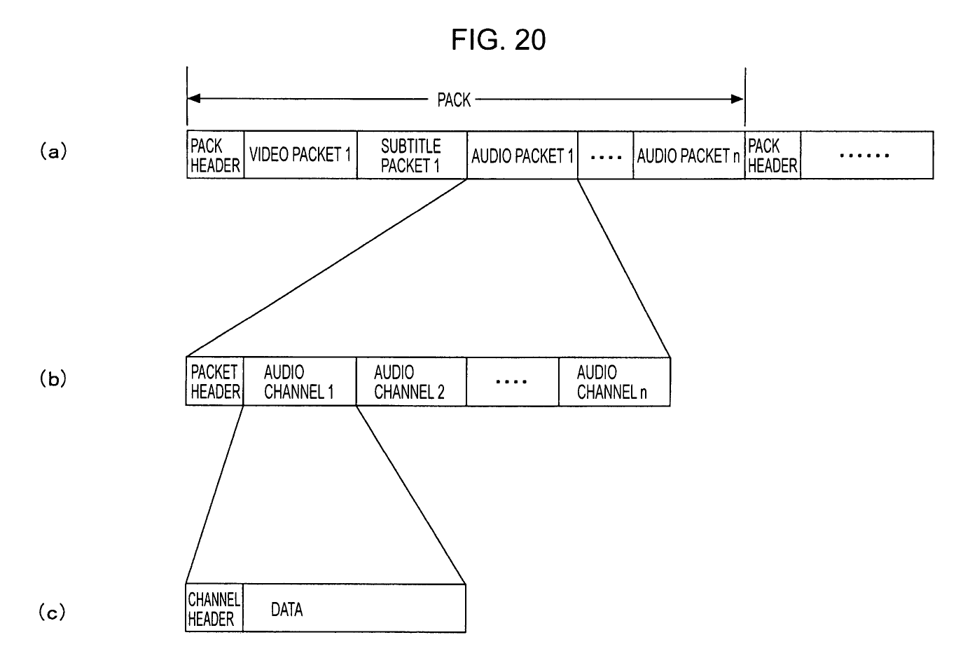

FIG. 20 is a schematic view showing an example of data structure of a recording medium in that case.

In the recording medium shown in part (a) of FIG. 20, packs composed of, for example, a video packet, a subtitle packet, a plurality of audio packet 1, audio packet 2, . . . audio packet n are formed. A pack header is attached to the beginning thereof. In the pack header, for example, additional information serving as a reference during synchronous playback is given.

As shown in part (b) of FIG. 20, the audio packet is composed of a plurality of audio channel 1, audio channel 2, . . . audio channel n, and a packet header is attached to the beginning thereof. In the packet header, for example, various kinds of control data used for audio control are recorded. For example, a sampling frequency, the number of multiplexing channels, a crossover frequency, a data coding method code indicating a data coding method, an audio signal specification code indicating the specification (format) of an audio signal playback method, etc., are recorded.

In each audio channel, as shown in part (c) of FIG. 20, a channel header is attached to the beginning of the data. In the channel header, for example, pieces of data indicating a channel number, a frequency band, a gain, and the amount of phase are recorded as additional information.

Here, a description is given of an example of the configuration of an AV system capable of playing back the above-described optical disc.

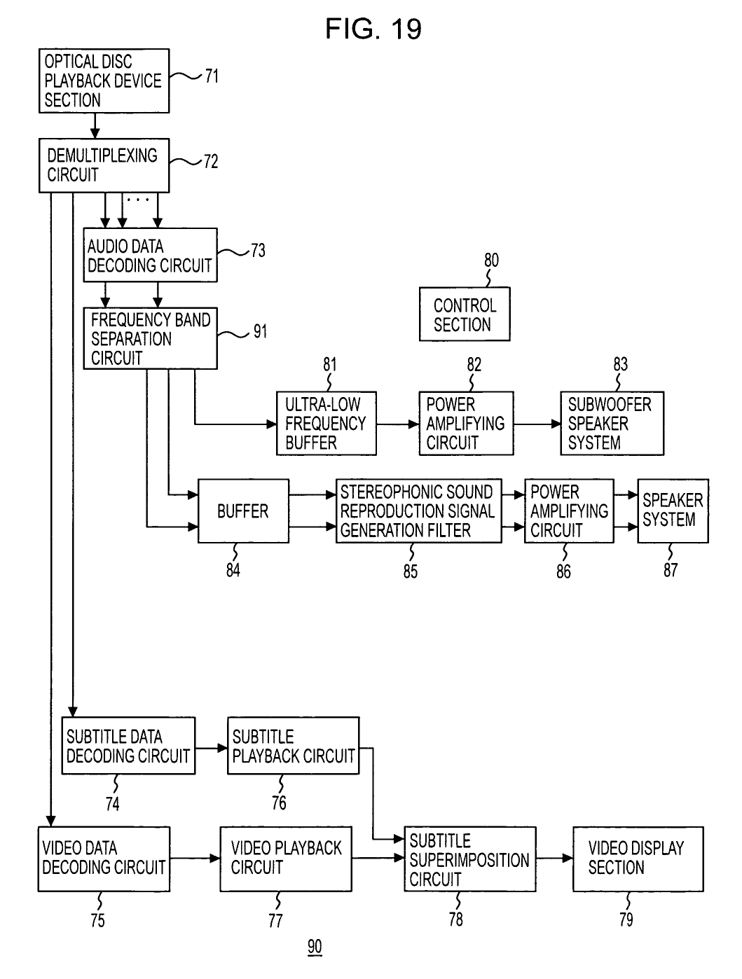

FIG. 19 is a block diagram showing the configuration of the above-described AV system. It is assumed in this case that video data and subtitle data are multiplexed with audio data on the recording medium. Furthermore, it is assumed in this case that, as audio data to be recorded on a recording medium, audio data is recorded in which a signal picked up by the above-described dummy head microphone is separated into low frequency components and high frequency components, the high frequency components are delayed, and these components are multiplexed.

In FIG. 19, an optical disc playback section 71 reads multiplexed data recorded on an optical disc. A demultiplexing circuit 72 detects and separates the header, the video data, the subtitle data, and the audio data of a plurality of channels from the read multiplexed data.

An audio data decoding circuit 73 decodes the audio data transmitted from the demultiplexing circuit 72. At this time, the audio data decoding circuit 73 outputs the decoded audio data to a buffer 84, and outputs the ultra-low frequency data to an ultra-low frequency buffer 81.

A subtitle data decoding circuit 74 decodes subtitle data from a subtitle packet in accordance with timing information contained in the header information transmitted from the demultiplexing circuit 72, and outputs the subtitle data. Similarly to that described above, a video data decoding circuit 75 decodes the video data in accordance with the frame rate contained in the header information transmitted from the demultiplexing circuit 72, and outputs the data.

A subtitle playback circuit 76 performs a predetermined playback process on the subtitle data decoded by the subtitle data decoding circuit 74, and outputs the data as a subtitle signal. A video playback circuit 77 performs a predetermined playback process on the video data decoded by the video data decoding circuit 75, and outputs the data as a video signal.

A subtitle superimposition circuit 78 performs a so-called superimposition process of superimposing a subtitle signal onto a video signal in accordance with timing information, such as subtitle control information, recorded as the header information in the packet header attached to the subtitle packet, converts the signal into a video signal format in compliance with a video display section 79, and outputs the signal. The video display section 79 displays a video image on the basis of the video signal supplied from the subtitle superimposition circuit 78.

A power amplifying circuit 82 amplifies the ultra-low frequency signal from the ultra-low frequency buffer 81 to a predetermined level, and thereafter outputs the signal to a subwoofer speaker system 83, whereby the signal is output.

A stereophonic sound reproduction signal generation filter 85 performs a stereophonic sound reproduction signal generation process on the audio signal from the buffer 84, and thereafter outputs the signal to a power amplifying circuit 86. In the power amplifying circuit 86, after the audio signal from the stereophonic sound reproduction signal generation filter 85 is amplified to a predetermined level, the signal is output to a speaker system 87, whereby the signal is output.

A control section 80 controls the entire AV system 70 and performs various kinds of control by using the header information demultiplexed from the multiplexed data in the demultiplexing circuit 72. For example, switching control for switching the operation of the audio data decoding circuit 73 is performed in accordance with the sampling frequency and the data coding method code attached to the packet header shown in FIG. 20.

Furthermore, only the audio packet matching the specification of the audio reproduction system is selected from the audio signal specification (format) code attached to the packet header in a similar manner. For example, if the audio packet 1 is an audio packet of a binaural system, the audio packet being picked up by the sound apparatus according to this embodiment, and the audio packet 2 is an audio packet of a surround playback system, the audio packet 1 is selected.

Therefore, if the AV system 70 plays back the sound signal recorded on the recording medium, it is possible to enable the listener to experience a target sensation of sound localization.

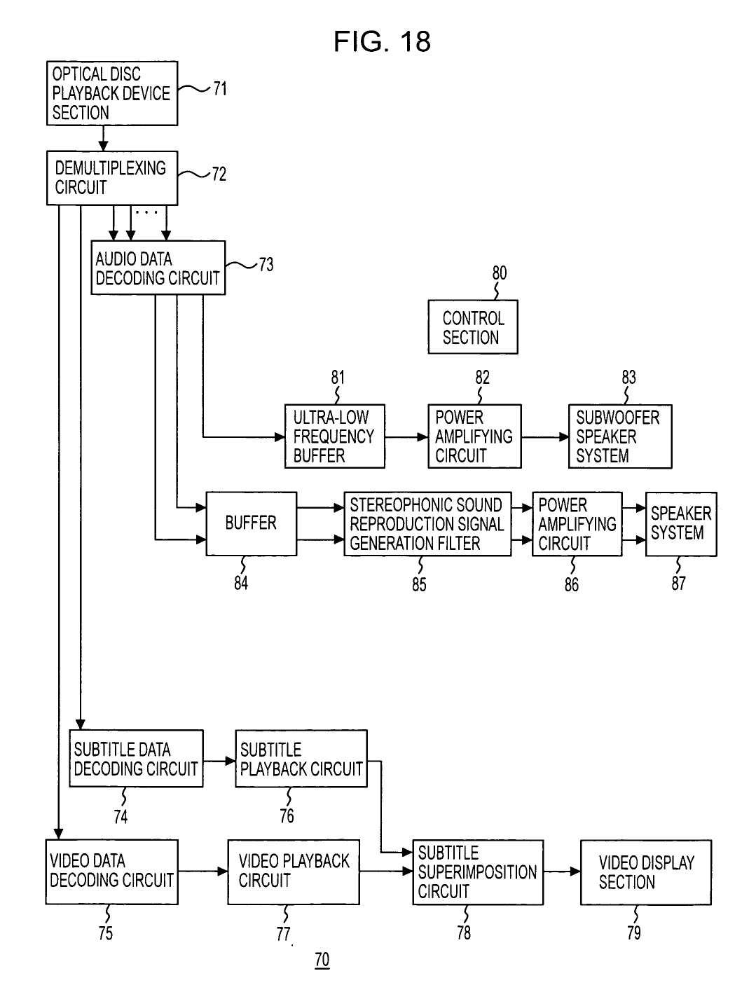

In the AV system 70 shown in FIG. 18, a description is given by assuming that a signal picked up by the dummy head microphone is separated into low frequency components and high frequency components, the high frequency components are delayed, and audio data in which the components are multiplexed is recorded on a recording medium such as an optical disc. However, this is only an example. For example, audio data that is not subjected to band division may also be multiplexed and recorded on a recording medium.

The block configuration of the AV system in that case is shown in FIG. 19. Blocks in FIG. 19, which are identical to the blocks shown in FIG. 18, are designated with the same reference numerals, and accordingly, detailed descriptions thereof are omitted.

An AV system 90 shown in FIG. 19 differs from the AV system 70 shown in FIG. 18 in that, as shown in FIG. 19, a frequency band separation circuit 91 is provided between the audio data decoding circuit 73 and the ultra-low frequency buffers 81 and 84.

In such a frequency band separation circuit 91, the audio data that is read from the optical disc and that is decoded by the audio data decoding circuit 73 is separated into high frequency data and low frequency data. The high frequency data and the low frequency data that are separated by the frequency band separation circuit 91 in this manner are supplied to the buffer 84.

The embodiment has been discussed above by assuming that, in such an AV system, various kinds of data to be played back, in which video data, subtitle data, and audio data of a plurality of audio channels are multiplexed, are recorded on a recording medium, such as an optical disc. However, the AV system can also be configured in such a way that data to be played back, such as video data, subtitle data, and audio data of a plurality of audio channels, is received, for example, via a network.

In such an AV system, a subwoofer playback system for playing back ultra-low frequency components is provided. However, such a subwoofer playback system needs not to be provided.

In the sound apparatus according to this embodiment, a description is given by assuming that a sound signal picked up by the sound pickup block is recorded on an optical disc by the disc recording section 100. However, the recording medium is not restricted to an optical disc. Alternatively, for example, a Blue-Ray system compliant disc, a CD (Compact Disc) system compliant disc, a mini disk (MD), a hard disk drive (HDD), or a memory card such as a flash memory, can be used as a recording medium.

1. A sound pickup apparatus comprising:
extraction means for extracting low frequency components from an input signal having a head-related transfer function;
delay means for delaying at least high frequency components of said input signal; and
combining means for combining the low frequency components extracted by said extraction means and the high frequency components delayed by said delay means.

2. The sound pickup apparatus according to claim 1, wherein said input signal is a sound signal picked up by using a dummy head microphone.

3. The sound pickup apparatus according to claim 1, wherein said input signal is a sound signal picked up by using a microphone mounted on a human being.

4. The sound pickup apparatus according to claim 1, wherein said input signal is a signal in which a head-related transfer function is superposed onto a sound source signal.

5. The sound pickup apparatus according to claim 1, wherein said extraction means can extract high frequency components from said input signal.

6. A sound pickup apparatus comprising:
extraction means for extracting low frequency components from a sound source signal;
delay means for delaying at least high frequency components of said sound source signal;
combining means for combining the low frequency components extracted by said extraction means and the high frequency components delayed by said delay means; and
head-related transfer function providing means for providing a predetermined head-related transfer function to at least the low frequency components of said sound source signal.

7. The sound pickup apparatus according to claim 6, wherein said head-related transfer function providing means provides a predetermined head-related transfer function to said sound source signal.

8. The sound pickup apparatus according to claim 6, wherein said head-related transfer function providing means provides a predetermined head-related transfer function to the output of said extraction means.

9. The sound pickup apparatus according to claim 6, wherein said head-related transfer function providing means provides a predetermined head-related transfer function to the output of said extraction means and the output of said delay means.

10. The sound pickup apparatus according to claim 6, wherein said extraction means can extract high frequency components from said sound source signal.

11. A sound pickup method comprising the steps of:
extracting low frequency components from an input signal having a head-related transfer function;
delaying at least high frequency components of said input signal; and
combining said low frequency components and said high frequency components.

12. A sound pickup method comprising the steps of:
extracting low frequency components from a sound source signal;
delaying at least high frequency components of the sound source signal;
combining said low frequency components and said high frequency components; and
providing a predetermined head-related transfer function to at least the low frequency components of said sound source signal.

13. A recording medium having recorded thereon a sound signal in which low frequency components are extracted from an input signal having a head-related transfer function, at least high frequency components of the input signal are delayed, and said low frequency components and said high frequency components are combined.

14. A recording medium having recorded thereon a sound signal in which low frequency components are extracted from a sound source signal, at least high frequency components of the sound source signal are delayed, said low frequency components and said high frequency components are combined, and a head-related transfer function is provided to at least the low frequency components of said sound source signal.
